(19) United States
(12) Patent Application Publication
(10) Pub. No.: US 2026/0200166 A1
(43) Pub. Date: Jul. 16, 2026

(54) TECHNIQUES FOR SECURING MODELS USING A BALL PLUNGER

(71) Applicant: Institut Straumann AG, Basel (CH)

(72) Inventors: Maximilian Sattler, Munich (DE); Florian Seidl, Worth (DE); Maximilian Hoyer, Zorneding (DE); Markus Altenbuchinger, Munich (DE)

(73) Assignee: Institut Straumann AG, Basel (CH)

(21) Appl. No.: 19/134,530

(22) PCT Filed: Nov. 30, 2023
(86) PCT No.: PCT/IB2023/062086

§ 371 Date: May 30, 2025

Related U.S. Application Data
(60) Provisional application No. 63/428,967, filed on Nov. 30, 2022.

(51) Int. Cl. B29C 51/36; B29C 33/30; B29C 33/38; B29C 33/42; B29C 51/26; B29C 51/46; B29L 31/00; B33Y 80/00

(52) U.S. Cl. CPC B29C 51/36; B29C 33/303; B29C 33/424; B29C 51/268; B29C 51/46; B33Y 80/00; B29C 2033/385; B29C 33/3892; B29L 2031/7536

(57) ABSTRACT

The present disclosure discusses techniques for securing thermoform models, including a locator plate for receiving and securing individually unique dental models having a polygon cutout, wherein the locator plate has at least one ball plunger positioned within a raised polygon, the at least one ball plunger having a cylindrical body, a spring, and a ball extending partially outside the cylindrical body. The present disclosure also includes a system for thermoforming an orthodontic aligner and methods thereof.

### CROSS-REFERENCE TO RELATED APPLICATIONS

This application claims priority to and the benefit of U.S. Provisional Application Ser. No. 63/428,967 entitled “Techniques for Securing Models Using a Ball Plunger” filed on Nov. 30, 2022; the contents of which are incorporated in their entirety herein.

### FIELD OF THE TECHNOLOGY

The present technology relates to dental appliance manufacturing techniques. More specifically, this technology relates to techniques for securing models by using a ball plunger plate.

### BACKGROUND

Orthodontic aligners are appliances intended to make a series of discrete tooth position corrections aimed at aligning the teeth correctly. Aligners are equivalent to having bracket/wire braces for orthodontic treatment, but they have many advantages. For example, aligners are often transparent or semi-transparent, comfortable, and removable for cleaning and they allow a patient to eat anything they want. The manufacture of aligners traditionally begins with generating a digital model of the patient's teeth, either by scanning the patient's teeth, or by making a dental impression of the patient's teeth and then scanning the impression. Once a digital model of the patient's teeth has been acquired, physical dental models can be fabricated (e.g. using 3D printing techniques) to provide a positive model of the teeth, also known as the dental arch.

When an intra-oral scanning device (IOS device) is used to scan a patient's teeth, three-dimensional computer aided design (CAD) representations can be imported by custom software. The custom software allows the operator to move individual teeth in specific and discrete movements to achieve the final dental arch of aligned teeth.

A 3D printed arch model is washed and then allowed to dry. Once dried, a polymer is thermoformed over the top of the 3D printed arch model.

The thermoformed part is then laser marked with part identification. The laser marked, thermoformed part is then cut by one of several methods so that the aligner that goes to the customer can be separated from the excess aligner material.

The aligner is then polished in a part tumbling process to remove burrs and sharp edges. The aligners are inspected and then sealed in bags to be shipped to the customer's orthodontist, or directly to the patient.

Previous thermoforming designs included problems with securely locating a 3D printed arch model for pressure forming a heated plastic film with minimal added material. In addition to having excess material, these designs did not always hold the model accurately. Current location feature plates in thermoforming models have low robustness in fit, orientation and position. In particular, the mounted model is either too loose, causing it to rotate and move, or too tight, causing the model to not fit properly on the plate or substrate. This leads to large number of repeated process steps and touch ups.

### SUMMARY

The present technology solves the above problems by employing a locator plate having a raised polygon feature and one or more spring/elastic/active elements with a defined force that applies a pre-tension to the mounting geometry.

The technology uses one or more defined contact areas to guarantee a defined position and orientation and one or more defined gaps to allow positioning and orientation according to contact areas. This ensures a proper fit, correct position, and orientation of the dental model on a base plate.

Additional advantages of the present technology include the robustness to make thousands of clear aligners per day while reducing thermoforming issues and improving accuracy over competitor thermoforming processes as well as the cutting/separation process.

The present technology also saves cost and time in central production and reduces aligner remakes, manual corrections/touch ups, and waste rate in clear aligner manufacturing. Thus, the present technology increases accuracy, reliability, and scalability of aligner automated production.

In an embodiment, the technology is directed to a locator plate for receiving and securing individually unique dental models that contains a raised polygon extending from a surface of the locator plate and having a rectangular bottom portion and a triangular top portion and at least one ball plunger positioned within the raised pentagon.

The at least one ball plunger may have a cylindrical body, a spring, and a ball extending partially outside the cylindrical body.

A portion of the ball extending partially outside the cylindrical body of the ball plunger may extend from the rectangular bottom portion of the raised pentagon and away from an apex of the triangular top portion of the raised pentagon.

In some embodiments, the raised polygon is a pentagon shape having a rectangular bottom portion and triangular top portion.

In some embodiments, the raised pentagon is chamfered.

In some embodiments, the ball lies partially within the cylindrical body and engages with the spring to move along a longitudinal axis of the cylindrical body.

In some embodiments, wherein the locator plate comprises raised lettering spaced away from the raised pentagon.

In some embodiments, the locator plate has a dental model affixed to the raised pentagon for forming a dental aligner, wherein the ball plunger engages with a portion of the dental model to secure the dental model to the locator plate.

In some embodiments, a polymer sheet is drawn over the dental model.

In some embodiments, the at least one ball plunger includes a pair of ball plungers positioned within the raised pentagon.

In alternative embodiment, the present technology is directed to a method of thermoforming a dental aligner. The method steps include printing a 3D dental model including a positive model of a dental arch and a 3D printed locator tab positioned within an interior of the dental arch, providing a locator plate having a raised polygon extending from a surface of the locator plate, wherein the raised polygon includes at least one ball plunger having a ball extending partially away from a surface of the raised polygon, and securing the 3D dental model to the locator plate by positioning the raised polygon within the polygon cutout such that the at least one ball plunger engages with the polygon cutout; and thermoforming a polymer sheet over the dental model secured to the locator plate.

In some embodiments, printing the 3D dental model includes printing edges of a polygon cutout within the 3D printed locator tab.

In some embodiments, the raised polygon of the locator plate has an apex oriented toward an incisal portion of the dental arch indicating a proper orientation of the 3D dental model with respect to the raised polygon of the locator plate.

In some embodiments, the raised polygon of the locator plate and the polygon cutout within the 3D printed locator tab are pentagonal.

In some embodiments, the pentagonal raised polygon includes a rectangular portion and a triangular portion, and an apex of the triangular portion is removed to produce a gap between the apex of the triangular portion and the 3D dental model.

In some embodiments, the 3D dental model is secured to the locator plate, a defined gap exists between three sides of the rectangular portion of the pentagonal raised polygon and the polygon cutout within the 3D printed locator tab.

In some embodiments, the at least one ball plunger includes a pair of ball plungers positioned within the raised pentagon.

In an embodiment, the technology is directed to a system for thermoforming an orthodontic aligner having a locator plate having a raised polygon extending from a surface of the locator plate with at least one ball plunger positioned within the raised pentagon. The at least one ball plunger has a cylindrical body, a spring, and a ball extending partially outside the cylindrical body. The system further includes a 3D dental model including a positive model of a dental arch and a 3D printed locator tab positioned within an interior of the dental arch. The 3D dental model defines edges of a polygon cutout within the 3D printed locator tab. The 3D dental model mates with the locator plate by positioning the raised polygon within the polygon cutout and engaging the ball of the ball plunger with a portion of the polygon cutout. The system may also include a heat source for thermoforming a polymer sheet over the 3D dental model once secured to the locator plate.

In some embodiments, the 3D printed locator tab includes cutout lettering or raised lettering positioned along one or more edges of the polygon cutout.

In some embodiments, the system further includes a camera for viewing and identifying the cutout lettering or raised lettering positioned along one or more edges of the polygon cutout.

In some embodiments, the locator plate further defines a plurality of channels in fluid communication with a vacuum pump to generate a vacuum within the locator plate.

In some embodiments, the locator plate has a modular design allowing the raised polygon to be secured to and removed from the locator plate.

In some embodiments, the locator plate also includes a removable active insert including the plunger positioned within the raised polygon, and a bottom ball plunger extending from a surface of the removable active insert opposite from the raised polygon.

### BRIEF DESCRIPTION OF THE DRAWINGS

The technology will be more fully understood from the following detailed description taken in conjunction with the accompanying drawings, in which:

FIG. 1 shows a top view diagram of the locator plate having a raised chamfered pentagon with one ball plunger.

FIG. 2 shows a top view diagram of the raised chamfered pentagon shape of the locator plate with two spring plungers.

FIG. 3 shows a 3D perspective of the ball plunger.

FIG. 4 shows a 3D top and side view diagram of a raised pentagon, locator pin, three locator cones, and single ball plunger, and lettering of the locator plate.

FIG. 5 shows a 3D bottom and side view diagram view of the locator plate.

FIG. 6A shows a top perspective view of a dual spring plunger with screw holes used to mount the feature to a larger base plate. FIG. 6B shows a top perspective view of a mono spring plunger with screw holes used to mount the feature to a larger base plate.

FIG. 7A shows a top perspective view of circular locator plate with a spring plunger design that is seated flush with the circular plate. FIG. 7B shows a side view diagram of the same.

FIG. 8 shows a top view of a raised pentagon and cylindrical locator pin of the locator plate.

FIG. 9A shows a perspective view illustrating mounting of the location feature to the base plate. FIG. 9B is an exploded view of the elements shown in FIG. 9A.

FIG. 10A shows a flow chart of an exemplary method embodiment of the thermoforming technology. FIG. 10B shows a flow chart of another exemplary method embodiment of the thermoforming technology

FIG. 11 shows a top view of an alternative embodiment of the raised pentagon and ball plunger system wherein the active element (ball plunger) is separated from the mold as a retractable insert.

FIGS. 12A-12C show different perspectives of the retractable active element insert, including the top view perspective (FIG. 12A), side view perspective (FIG. 12B), and the bottom view perspective (FIG. 12C).

FIGS. 13A-13B show a slide perspective of the retractable active element insert and the mold. In FIG. 13A, the downward pointing arrow indicates the direction of the force applied to reach the zero (final) position of the insert. In FIG. 13B, the retractable active element insert is in the zero (final) position.

FIG. 14 shows a side perspective of a polymer/thermoplastic aligner material thermoformed over a dental model.

### DETAILED DESCRIPTION

The present technology includes a locator plate for receiving and securing individually unique dental models having a raised polygon cutout together with one or more ball plungers positioned within the raised polygon, the at least one ball plunger having a cylindrical body, a spring, and a ball extending partially outside the cylindrical body for improved securing thermoforming models. The technology further includes a system for thermoforming an orthodontic aligner and a method of thermoforming a dental aligner. Although many of the embodiments described herein relate to securing a model during a thermoform process, the techniques may also be used to secure a model during other aligner manufacturing processes, such as trimming of the aligner material.

The present technology also allows for additional manufacturing information to be easily visible as needed. The present technology is significantly more flexible while using less material than competing designs and advantageously presents manufacturing information in an optimal way for character recognition.

The raised polygon may be a pentagon shape with a rectangular bottom portion and a triangular top portion. It was surprisingly discovered that the shape of the raised pentagon is compact enough to fit internal to most human dental arches, robust enough to not be damaged or broken during processing, easy to manufacture, quickly shows product orientation, easy to mate to, and has enough surface area to keep parts from rotating. In particular, the pointed end of the pentagon is easy to orient to; the shape allows for a front-to-back loading action that is ergonomic and self-aligning; and the flat sides of the shape prevent 3D arch rotation. Moreover, the ball plunger design applies a force to the dental model, which advantageously eliminates contact area gaps between the dental model and the raised pentagon.

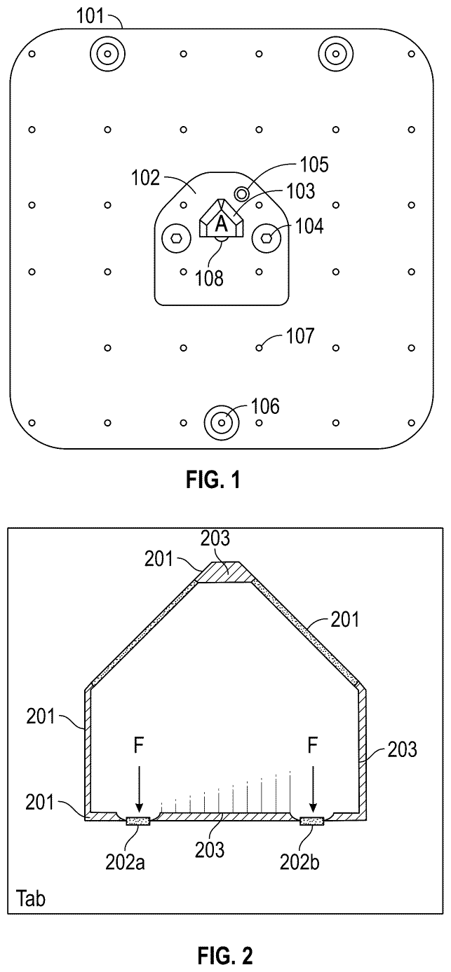

In an example, the technology is directed to a locator plate for receiving and securing individually unique dental models such as shown in FIGS. 1, 4, 5, 7, and 9.

In some examples, the locator plate has a raised polygon, such as a pentagon, extending from a surface of the locator plate and having a rectangular bottom portion and an isosceles triangle top portion and a locator pin as shown in FIGS. 1, 2, 4, 6, 7, and 9. In some examples, the raised pentagon is located in the center of the locator plate. In some examples, a locator pin is spaced from the raised pentagon, the locator pin extending from the surface of the locator plate.

In some examples, the locator plate further has a first locator cone, a second locator cone, and a third locator cone spaced away from the raised pentagon in a triangular arrangement as shown in FIGS. 1, 4, and 7.

In some examples, at least one edge of the raised pentagon is chamfered as shown in FIGS. 1, 2, 4-7, and 9. The chamfered edges of the raised pentagon can help the dental model more easily fit into place.

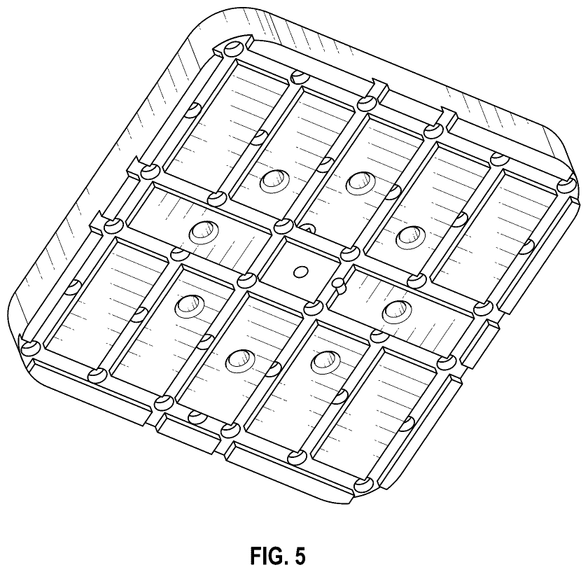

In some examples, the locator plate has raised lettering spaced away from the raised pentagon as shown in FIG. 4. The raised lettering can include a plate identifier. As also shown in FIG. 4, the tab area of the dental model that defines a cutout portion can also include raised or cutout lettering. The lettering on the model tab can include a product identifier, a case identifier, a batch identifier, or another type of code that is used in downstream processing and manufacturing steps during the aligner production process.

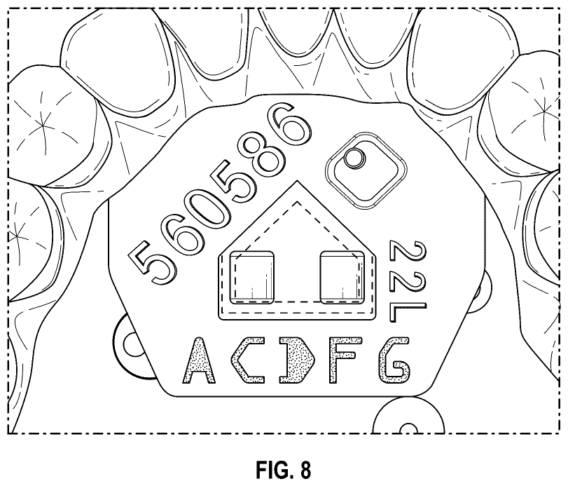

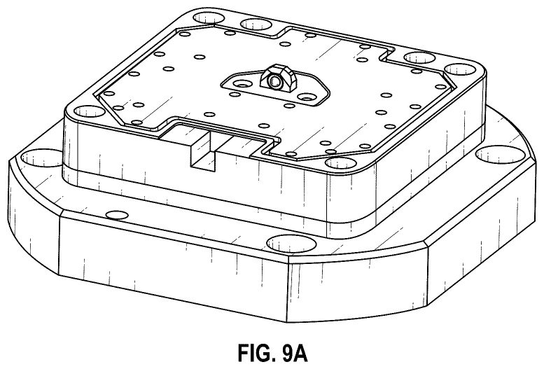

In some examples, the locator plate further has a dental model affixed to the raised pentagon for forming a dental aligner such as shown in FIG. 8. In some examples, the locator plate further has a polymer sheet drawn over the dental model (not shown).

Specifically, FIG. 1 shows a top view diagram of an exemplary locator plate having a location feature 102 mounted to the base plate 101 that can be screwed to the plate via the mounting holes 104. The location feature 102 has a raised chamfered pentagon 103 having a rectangular bottom and isosceles triangle top shape and a locator pin 105. After experimenting with various shapes, the pentagon shape having a rectangular bottom portion and an isosceles triangle top portion demonstrated optimal fit and alignment accuracy when mating a dental model with a locator plate. The pin location feature 105 feature also assists in locating and positioning the dental model to ensure superior alignment. The pin feature is spaced away from the raised pentagon and is not limited in number, size, or location on the locator plate.

The chamfer around the raised pentagon 103 makes it easier for the locator plate to mate to the dental model and reduces the likelihood of flashing or extra material from the 3D printing process affecting proper mating. In an embodiment, the locator plate has a chamfer on the back and sides of the pentagon shape, which also helps for alignment.

Locator cones 106 are spaced away from the raised pentagon and the locator pin in a triangular arrangement and are another locator feature that assist in locator plate arrangement relative to the dental model. Preferably, the locator cones 106 can be cone-shaped indentations within the locator plate and are arranged as three cones that are spaced in a triangular formation as shown in FIGS. 1, 5, and 7. During the thermoform process, a portion of the polymeric material can be thermoformed into the locator cones 106, resulting in three thermoformed features in the polymeric material. In some embodiments, these thermoformed cone features can assist with orienting the aligner material and dental model during downstream processes, such as laser marking.

The mounting holes 104 can be used to securely mount the locator features to the base plate and to various other components in an assembly line manufacturing process.

The base plate also has smaller holes 107, which allow for air to escape during the thermoforming process that may get trapped between the thermoforming material and the locator plate and allow for a more secure fit. In some embodiments, a vacuum system can be incorporated into the thermoforming system that can provide suction through the smaller holes 107 to assist with holding the polymeric material securely to the locator plate.

FIG. 1 also shows a ball plunger 108 positioned within the raised pentagon 103. A portion of the ball extending partially outside the cylindrical body of the ball plunger 108 extends from the rectangular bottom portion of the raised pentagon, and away from an apex of the triangular top portion of the raised pentagon. The spring of the ball plunger has one or more spring elements that are elastic and applies a pre-tension during the mounting and positioning of the dental model. While a ball plunger is preferred, any other flexible elements with other geometry may be used for applying a tension and controlling any gaps during the thermoforming process. In some embodiments, the pin location feature 105 can be omitted and the dental model can be held properly in place using only the raised polygon and the ball plunger 108.

FIG. 2 provides a top view diagram of an alternative raised pentagon location feature with two spring plungers 202a and 202b that maintain a defined pre-tension during mounting and thermoforming. The mounting process during thermoforming is optimized by using defined contact areas 201, which provide defined gaps 203. The defined gaps combined with the pre-tension from the ball plungers balances production tolerances as the mounting geometry should not be too tight or too loose. In a preferred example, the raised pentagon feature does not rotate. In an alternative example, one or more location features are capable of rotation or removable to improve modularity. These features can also secure the model during the aligner trimming process, and other post-thermoforming processing steps, according to some embodiments.

The defined gaps 203 shown at the peak, sides, and bottom of the pentagon are not limited in gap size or range of sizes. The angled triangle section of the pentagon has a contact area 201 with little to no gap because the ball plungers 202a and 202b push the dental model back and thus eliminates the gap at this angled contact area 201. The tip of the angled section may have a defined gap to allow contact on both sides of the location feature. Some gap is preferred at the very tip of the triangular portion to allow the contact on the angled portions to be flush when the ball plungers are engaged during mounting. A small gap is preferred on the either side of the pentagon to allow some movement.

In an example, the gap 203 on any side ranges from 0.01 to 1 mm and can vary based on multiple parameters, including the maximum movement of the ball plungers that guarantee a pre-tension, the deviation of a printed part or tab, and the geometric accuracy of the location feature. In a preferred example, the gap on each side is approximately 0.2 mm. In a preferred example, the ball plunger movement may range from 0.7 to 1 mm.

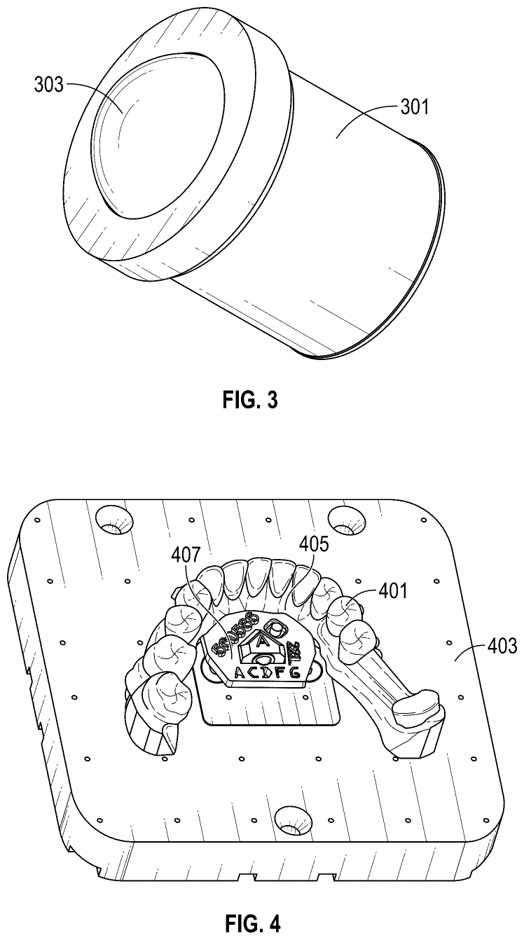

FIG. 3 shows a 3D perspective view of the geometry of the ball plunger design, which has a cylindrical body 301, an internal spring (not shown), and a ball 303 extending partially outside the cylindrical body. The ball 303 and spring provide a pre-tension when the dental model is mounted to the location feature for perfecting fit.

FIG. 4 shows a 3D top and side perspective of the locator plate system, including the dental model 401 mated to the locator plate 403. The dental model 401 includes a cutout pentagon shape formed within a tab portion on the interior area 405 of the arch of the 3D printed dental model 401. The location feature 407 (e.g., locator tab) can be positioned within the interior of the dental arch and can be formed during the 3D printing process. The location feature 407 in this embodiment includes a pentagon cutout shaped to be placed around a raised pentagon, as well as a pin cutout shaped to be placed around a locator pin. After experimenting with various shapes, the pentagon shape having a rectangular bottom portion and an isosceles triangle top portion demonstrated optimal fit and alignment accuracy when mating a dental model with a locator plate. The ball plunger provides tension to fill the gap and improve fit when the dental model is mounted and mated to the location feature.

FIG. 4 also shows a pin cutout, which assists in locating and positioning the dental model to ensure superior alignment. In FIG. 4, the pentagon cutout is chamfered. The chamfer makes it easier for the locator plate to mate to the dental model and reduces the likelihood of flashing or extra material from the 3D printing process affecting proper mating. In an embodiment, at least one edge of the raised pentagon feature is chamfered, which also helps for alignment.

After the dental model 401 has been secured to the locator plate 403, a polymeric material can be thermoformed over the dental model. Once the thermoforming process has completed, the polymeric aligner material is attached to the dental model 401 and remains attached to the dental model even after the dental model is removed from the locator plate. That is, while the locator plate has been removed, the dental model is still connected to the thermoformed sheet. In addition, the thermoformed polymeric material still needs to be cut out from the sheet and the dental model removed, before finishing work can occur (e.g., trimming, deburring, polishing, etc.) and before the final appliance (i.e., the aligner) is ready for the specific patient's use (i.e., patient corresponding to the attached model).

The polymeric material is a thin thermoformable material. The thickness of the polymeric material is not particularly limited but should be of sufficient thickness to thermoform around a dental model. Preferably, the polymeric material is less than 5 mm thick. More preferably, the thickness of the polymeric material may be from about 0.05 to about 5 mm thick.

Examples of thermoforming materials include but are not limited to polyethylene terephthalate (PET), polyethylene terephthalate glycol (PETG), thermoplastic polyurethane (TPU), polyvinyl chloride (PVC), and other biocompatible polymers with suitable elasticity and plasticity for thermoforming.

The polymeric material can include, for example, a multilayer polymeric material such as those described in U.S. Pat. Nos. 10,549,511; 10,870,263; 10,987,907; 11,325,358; 10,946,630; US Patent Publication No. 2022/0118747; PCT Application No. PCT/US2020/065928; PCT Application No. PCT/US2022/025306; and Provisional U.S. Patent Application No. 63/354,998; all of which are incorporated by reference in their entirety.

When the thermoforming material is exposed to heat, the material becomes more pliable, which allows the material to mold and take the shape of an imprint when adequate pressure is applied.

FIG. 4 also shows alphanumerical lettering that may be presented in various locations on the locator tab portion of the 3D printed dental model 401. This lettering is preferably in the form of raised lettering and spaced away from the pentagon cutout. In FIG. 4, the alphanumerical lettering is presented at three different locations on the locator tab around the pentagon cutout. The alphanumerical lettering is used to identify and match to a specific 3D model. For example, a computer having a detector (e.g., using an optical character recognition camera) can scan the locator tab, read the lettering, and match a dental model based on the lettering instructions, which further streamlines the thermoform process.

In an example, the alphanumerical lettering represents a case number and/or a step/arch identifier, which may be in the form of an encrypted code. In some embodiments, rather than being raised lettering, the lettering may be cut through the entire model to allow for more accurate reading from an optical character recognition camera. In a preferred embodiment, the length of the raised text is at least 1 mm, which overcomes potential issues in 3D printing. In an alternative embodiment, the lettering is entirely cut through the thickness of the locator tab. Having cutout lettering can further reduce the amount of material required during the 3D printing process.

FIG. 5 shows the locator plate of FIG. 4 from the bottom and side perspective. The gaps and smaller holes allow for air to escape during the thermoforming process that may get trapped between the thermoforming material and the locator plate and allow for a more secure fit.

The distances between an arch and the locator tab may be varied as each arch has a unique anatomical shape. Thermoforming digital software in combination with the lettering are used to determine a distance for each arch. Based on a known location of the arch, the software ensures the lettering is showing when it merges one or more locating features with the arch.

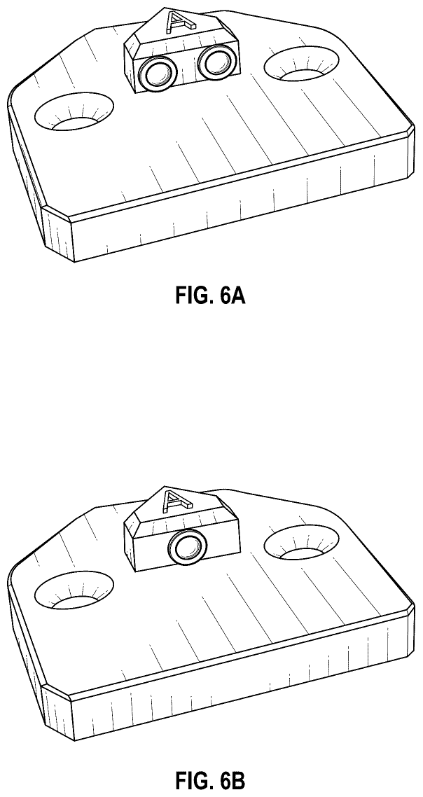

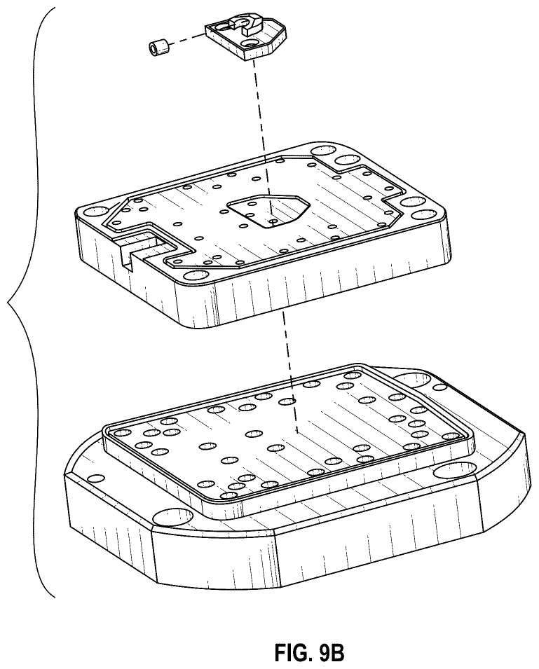

FIGS. 6A and 6B shows a model of the location feature having a chamfered raised pentagon and both a single (FIG. 6B) and dual (FIG. 6A) ball spring positioned on the bottom rectangular portion of the pentagon. In an example, a single ball plunger design is used. In an alternative example, a dual plunger design is used. The present technology is not limited in the number, size, or location of the ball plungers. The advantage of dual spring is that less spring tension may be required for each ball plunger. The advantage of a single ball plunger is one stronger spring plunger increases the alignment of the model on the location feature and less components can fail. The two cavities shown in these designs are screw holes used to mount the feature to a larger base plate as can be seen in FIGS. 9A-9B.

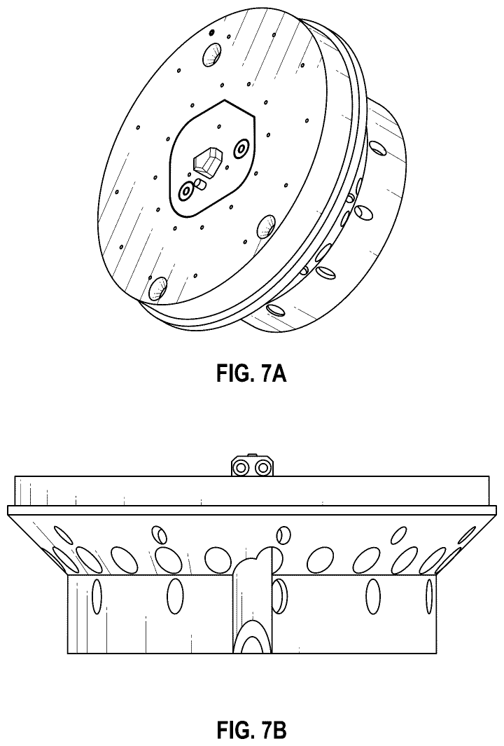

FIGS. 7A and 7B show an alternative rounded base plate with the location feature seated flush with the surface of the plate. FIG. 7A shows a 3D perspective of the top and side view and FIG. 7B shows a side perspective schematic with a dual ball plunger design.

FIG. 8 shows a picture of the dental model 801 mating with the raised polygon 802 that includes two ball plungers, according to an embodiment of the present disclosure. Although the dental model has a locator pin cutout, a locator pin is not present and is not necessary on the corresponding locator plate.

While FIG. 8 only shows some sides of the raised pentagon shape to be chamfered, more or fewer edges of the raised pentagon shape can be chamfered in order to assist with positioning the dental model on the locator plate. The locator pin can also have a chamfered upper surface, in some embodiments. The polygon shape 802 is preferably compact enough to fit internal to all human dental arches and chamfered for a better fit and avoiding dental model mating issues caused from defects in 3D printing. The polygon cutout in the dental model 801 is preferably robust enough to not be damaged or broken during processing. Additional advantages of the polygonal shape include that the shape is easy to manufacture, quickly shows product orientation, easy to mate to, and has enough surface area to keep parts from rotating.

FIGS. 9A-9B illustrate the locator feature being mounted to one or more base plates. FIG. 9A shows the mounted structure whereas FIG. 9B shows an exploded view of the structure shown in FIG. 9A. The numerous smaller holes within the base plates are connected to a vacuum suction and are used during the thermoforming and milling/cutting process to further secure the thermoform material. The vacuum/suction holes are not limited in diameter and can vary based on the desired thermoforming system utilized. In an example, the diameter may range from 0.1 mm to 1 mm. In a preferred example, the diameter may be approximately 0.7 mm.

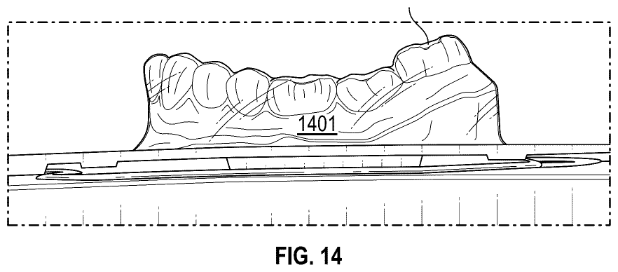

In an alternative embodiment, the ball and plunger system may be modular such that the active element is removable or retractable such as shown as a separated retractable active element 1110 from mold 1105 in FIG. 11. In addition to modularity, the insert provides additional advantages, including, for example benefitting the vacuum sealing of the thermoforming process because the retractability of the insert improves thermoform material friction for better ball/plunger alignment. The result is an improved thermoform seal (i.e., a polymer/thermoplastic aligner 1402) with a dental model 1401 as shown in FIG. 14.

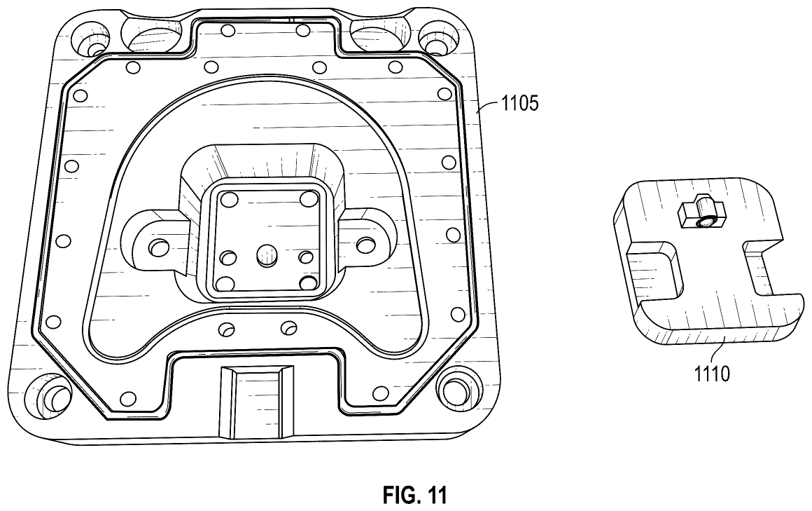

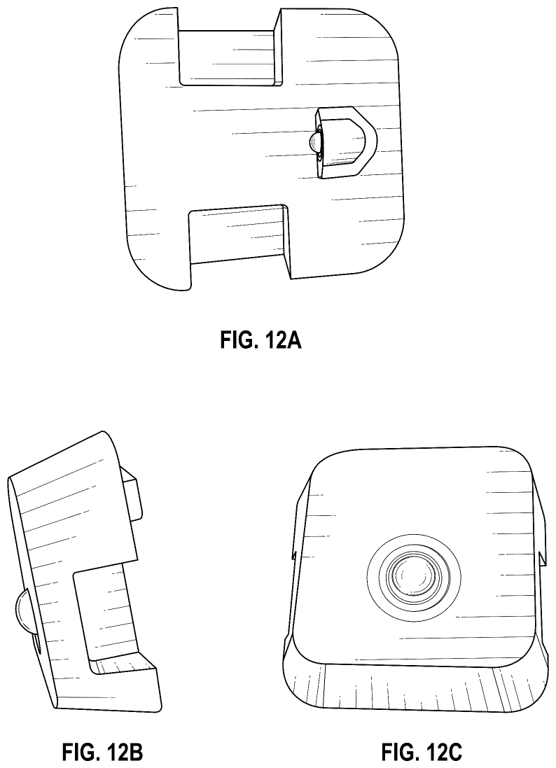

As shown in FIGS. 12A-12C, the retractable active element insert may have a bottom ball plunger and the raised polygon and ball/plunger system on opposite sides of the insert. As shown in FIG. 11, a raised dimple or other raised shape extending from the plate may be used to apply opposing force to the bottom ball portion of the insert.

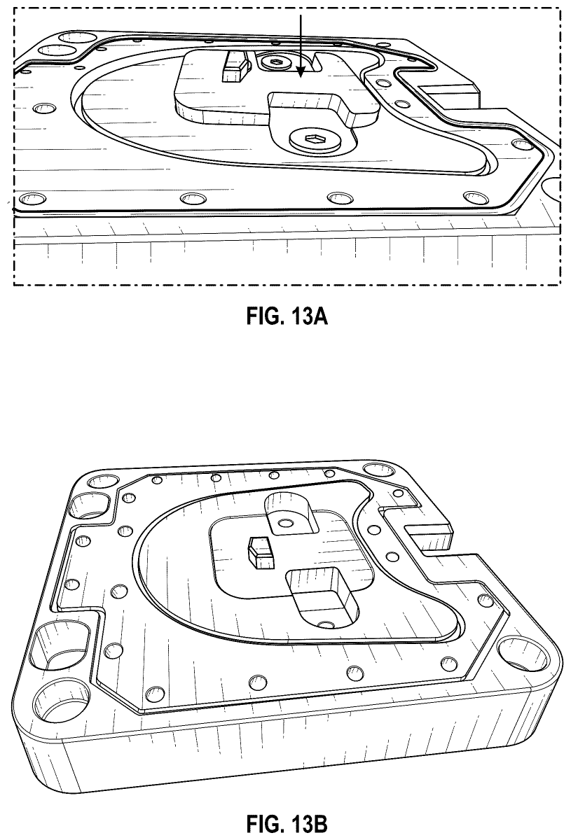

The downward arrow in FIG. 13A shows the direction of force applied to the insert to reach the zero (final) position of the insert seen in FIG. 13B. The plate may contain clamps on opposing sides of the insert (seen in FIG. 13A) that stabilize and affix the plate but do not affect the removability of the insert itself. FIG. 13A also illustrates a sealing member located within a groove within the locator plate. This sealing member can help apply a vacuum to fix the thermoformed aligner in place more securely during a trimming process. An additional inner seal can be used to close off the vacuum holes within the locator plate. The slightly raised position shown in FIG. 13A can be used during the trimming process to ensure that friction between the aligner material and sealing does not block alignment of the model. The retractable modular design discussed herein can provide process stability during trimming of the aligner material, in addition to providing process stability during thermoforming.

In a preferred example, the polygon is a pentagon shape, which is useful in that it is optimal for the above criteria. In a more preferred example, the pentagon shape has a substantially rectangular and slightly rounded bottom portion and an isosceles triangle top portion, with the raised pentagon located in the center of the locator plate. The point on one end is easy to orient to, which allows for a front-to-back loading action which is ergonomic and self-aligning and the flat sides of the rectangular portion of the pentagon help avoid the part from rotating. In some embodiments, the point on the raised pentagon 802 may be trimmed or cut off, as shown in FIG. 8, in order to further assist with mating the dental model with the locator plate.

The number of locator features is not limited. In an alternative example, the locator plate has more than one polygon cutout. In another example, additional locator cutouts such as additional locator pins may be used and may be optimized based on the specific design of the thermoforming system employed.

In an example, digital software is used to determine distance for each arch. The software may assist in tracking where the arch is and ensuring all text is showing when it merges the locating feature with the arch.

The lettering may include a case number and step/arch identifier above the edges of the polygon cutout. In one example, the lettering is an encrypted hexadecimal code. The lettering may be at the bottom of the polygon (e.g., pentagon) and may be cut through the entire model to allow for more accurate reading from an optical character recognition camera.

Any suitable length of raised lettering from the locator tab may be used. In a preferred example, the raised text may be at least 1 mm. In a preferred example, the cut through text is entirely cut through the thickness of the locator plate.

The raised polygon, locator pin, locator plate, and any other locating features may be chamfered. Chamfering advantageously allows for easier mating. Chamfering also advantageously helps reduce the likelihood of any flashing or extra material from the 3D printing process preventing parts in the thermoforming process from mating properly. In a preferred example, the locator plate has a chamfer on the back and sides of the pentagon to help for alignment.

The locator plate may include one or more grooves and/or holes to allow for air to escape during the thermoforming process that may get trapped between the film and the plate. These holes may also be used with a vacuum system to help securely hold the polymeric material to the locator plate.

In a preferred example, the locator pin is spaced from the raised polygon. Having the pin spaced from the polygon advantageously improves the locating feature(s) to keep the arch oriented in the correct location. Spacing the locator feature(s) apart advantageously minimizes potential variations in 3D arch dimensions from affecting the thermoforming process. 3D printed parts often result in some degree in variation in dimensions from part to part based on the printer accuracy. How well the 3D arch model is located will also affect the accuracy for laser marking and robotic trimming.

The present technology is further directed to methods of thermoforming aligners.

In general, methods of the present technology feature using a locator plate and dental model for the formation of specific, customized patient aligners. Methods of the present technology can include using a locator plate. As a result of incorporating the locator plate, thermoforming advantages, including superior fit and accuracy with dental models are achieved.

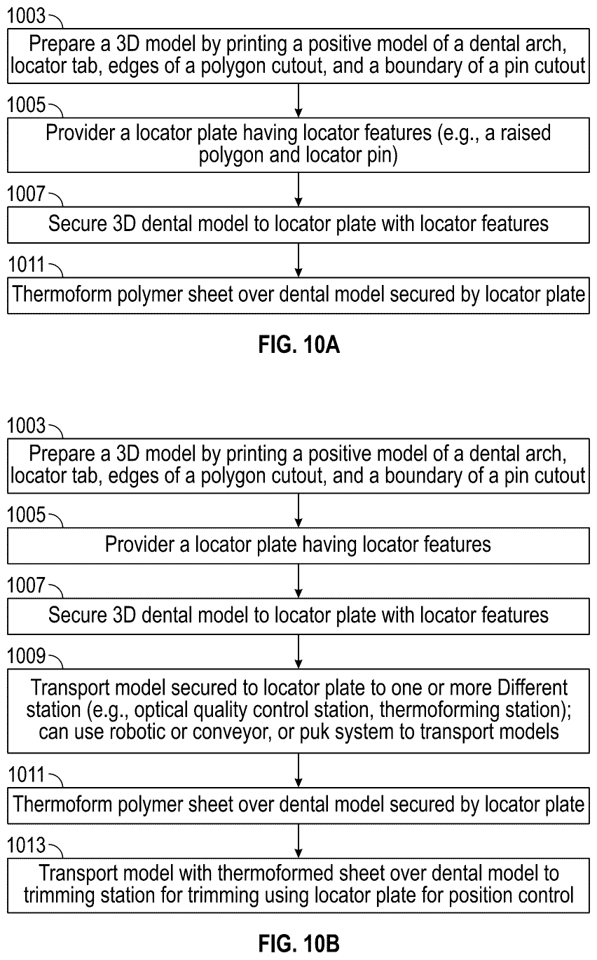

In one embodiment, the method of the present technology includes a number of steps such as demonstrated in the flowchart in FIG. 10A.

The method begins by preparing a dental model for thermoforming (1003). Dental models may be made by printing a 3D model. This model may include a positive model of a dental arch and a 3D printed locator tab. While the locator tab is not limited in position, the locator tab matches a respective locator cutout having one or more ball plungers. In an embodiment, the locator tab is preferably positioned within the interior of the dental arch. Printing may include printing edges of polygon cutout with the 3D printed tab as well as printing a boundary of a pin cutout within the 3D printed locator tab. These features are printed to match and correspond with a locator plate having respective cutouts of the features.

A locator plate having locator features as described herein is next provided for securing the dental model to the locator plate (1005). Preferred locator features of the locator plate include a raised polygon and a locator pin extending from a surface of the locator plate that assist in locating and securing to a 3D model. The locator plate may also include locator cones, which are concave conical indentations in the locator plate, that further assist in aligning the locator plate correctly.

The 3D dental model is then secured to the locator plate by positioning the locator features within the respective cutouts (1007). In a preferred example, the securing step involves positioning the raised polygon within the polygon cutout and positioning the locator pin within the pin cutout. The locator features of the locator plate will consistently ensure a secure fit with a dental model during the thermoforming process. The 3D model may also be moved into a proper position for thermoforming by repositioning the locator plate.

The raised polygon includes at least one ball plunger having a ball extending partially away from a surface of the raised polygon that helps secure the 3D dental model to the locator plate when the raised polygon is positioned within the polygon cutout such that the at least one ball plunger engages with the polygon cutout. When the one or more ball plungers are engaged, gaps are reduced or eliminated without being too tight or too loose based on the desired pre-tension, resulting in improved fit and finish during the thermoforming process.

Once the dental model is secured to the locator plate and in the proper position, the thermoforming material may be thermoformed over the dental model (1011). The thermoforming material is preferably a polymer/thermoplastic sheet or film that is biocompatible and moldable over dental models once sufficient heat and/or pressure is applied.

In some embodiments, after thermoforming has been completed the locator plate provides additional stability during a trimming process where excess aligner material is trimmed or cut from the aligner.

The above method may have the following additional exemplary features.

In an example of the method, the raised polygon has a specific shape that assists in ensuring a secure fit. For example, the raised polygon of the locator plate may have an apex oriented toward an incisal portion of the dental arch, which indicates a proper orientation of the 3D dental model with respect to the raised polygon of the locator plate.

In an example of the method, the raised polygon of the locator plate and the polygon cutout within the 3D printed locator tab are pentagonal, which is generally optimal for securing dental arches.

Additional features of the locator plate in the method includes three concave locator cones formed within the surface of the locator plate from which the raised polygon and locator pin extend.

In some examples of the method, the concave locator cones are positioned in a triangular arrangement with respect to the raised polygon. The triangular arrangement of the locator cones ensures a proper orientation of the locator plate.

The locator cones may contain a thermoforming portion that assists with securing a dental model. Therefore, in some examples of the method, thermoforming the polymer sheet further includes thermoforming a portion of the polymer sheet within the concave locator cones. Moreover, the triangular arrangement of the concave locator cones, when transferred to the thermoformed polymer sheet, may indicate an orientation of the thermoformed polymer sheet. For example, the orientation of the triangular arrangement of the concave locator cones can have a particular position with respect to the incisal portion of the dental arch model. In such an embodiment, knowing the position of the locator cones can indicate the position of the dental arch model.

FIG. 10B illustrates another exemplary embodiment of the method. The method of FIG. 10B includes the same steps as shown in the method of FIG. 10A, and further includes additional features. For example, in step 1009, the model secured to the locator plate is transported to a different station within a processing system. For example, using a conveyor belt or a puk system, the model can be transported to a quality control station, such as an optical quality control station. Once again the locator plate having locator features can be used in the transport as well as to position the locator plate within the quality control system for optical analysis. Once quality has been confirmed the locator plate can then be transported (e.g., using conveyor belt, robotic control, puk system, etc.) to a downstream processing station such as a thermoforming station. If the quality control system determines a problem with the model, the locator plate can be expelled from the system or returned to an upstream processing location.

After thermoforming a polymer sheet over the dental model secured to the locator plate (step 1011); the system can once again transport the locator plate to a different location (e.g., another quality control station, a trimming station, etc.). In the method shown in FIG. 10B, the locator plate containing the model with the thermoformed sheet is transported to a trimming station for trimming or milling of the thermoformed sheet. Once again, the locator plate with locator features can be used to position the locator plate within the trimming station.

The present technology is further directed to a system for thermoforming an orthodontic aligner having a locator plate having a raised polygon and one or more ball plungers and, optionally, a locator pin extending from a surface of the locator plate. The thermoforming system includes a three-dimensional dental model and locator plate described above to produce aligners made from a thermoforming material.

In addition to a method, the present technology includes an embodiment of a thermoforming system that utilizes the locator plate.

Specifically, the system includes a 3D dental model including a positive model of a dental arch and a 3D printed locator tab positioned within an interior of the dental arch. The dental model is based on a digital scan of the patient's teeth, or a physical impression of the patient's teeth. Preferably, the dental model is based on a digital scan of the patient's teeth using a mobile operating system device.

In an example of the system, the system includes a heat source for thermoforming a polymer sheet over the 3D dental model once secured to the locator plate. The heat source should sufficiently heat the thermoforming material such that the material molds over a dental model. The temperature at which heat is applied is dependent on the desired thermoforming material.

In some examples of the system, the system includes printing the 3D dental model that defines edges of a polygon cutout within the 3D printed locator tab and a boundary of a pin cutout within the 3D printed locator tab.

In additional examples of the system, the 3D dental model is capable of mating with the locator plate by positioning the raised polygon within the polygon cutout and positioning the locator pin within the pin cutout. The locator features, including, for example, the raised polygon, one or two ball spring plungers, locator pin cutout, and locator cones optimize the thermoforming process by precisely orienting the locator plate relative to the dental model for a secure fit as the thermoforming material is heated and pressed on the dental model.

In some examples of the system, the 3D printed locator tab includes cutout lettering or raised lettering positioned along one or more edges of the polygon cutout. In a preferred example, the lettering is in the form of a hexadecimal code and may be cut through the entire locator plate. This lettering assists in identification and instructions to the thermoforming system using any suitable detector such as a camera having optical character recognition software.

For identification, the system further includes a camera for viewing and identifying the cutout lettering or raised lettering positioned along one or more edges of the polygon cutout.

As to the locator plate of the system, in some examples, the locator plate further defines three concave locator cones as a locator feature formed within the surface of the locator plate from which the raised polygon and locator pin extend, the concave locator cones being positioned in a triangular arrangement with respect to the raised polygon. The triangular arrangement of the concave locator cones, when transferred to the thermoformed polymer sheet, are useful for indicating an orientation of the thermoformed polymer sheet.

Specific embodiments and methods of securing thermoforming models have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A locator plate for receiving and securing individually unique dental models, the locator plate comprising:
a raised pentagon extending from a surface of the locator plate and having a rectangular bottom portion and a triangular top portion; and
at least one ball plunger positioned within the raised pentagon, the at least one ball plunger having a cylindrical body, a spring, and a ball extending partially outside the cylindrical body,
wherein a portion of the ball extending partially outside the cylindrical body of the ball plunger extends from the rectangular bottom portion of the raised pentagon, and away from an apex of the triangular top portion of the raised pentagon.

2. The locator plate of claim 1, wherein the raised pentagon is chamfered.

3. The locator plate of claim 1, wherein the ball lies partially within the cylindrical body and engages with the spring to move along a longitudinal axis of the cylindrical body.

4. The locator plate of claim 1, wherein the locator plate comprises raised lettering spaced away from the raised pentagon.

5. The locator plate of claim 1, further comprising a dental model affixed to the raised pentagon for forming a dental aligner, wherein the ball plunger engages with a portion of the dental model to secure the dental model to the locator plate.

6. The locator plate of claim 5, further comprising a polymer sheet drawn over the dental model.

7. The locator plate of claim 1, wherein the at least one ball plunger includes a pair of ball plungers positioned within the raised pentagon.

8. A method of securing a dental aligner, comprising:
printing a 3D dental model including a positive model of a dental arch, and a 3D printed locator tab positioned within an interior of the dental arch, wherein printing the 3D dental model includes printing edges of a polygon cutout within the 3D printed locator tab;
providing a locator plate having a raised polygon extending from a surface of the locator plate, wherein the raised polygon includes at least one ball plunger having a ball extending partially away from a surface of the raised polygon;
securing the 3D dental model to the locator plate by positioning the raised polygon within the polygon cutout such that the at least one ball plunger engages with the polygon cutout; and
thermoforming a polymer sheet over the dental model secured to the locator plate.

9. The method of claim 8, wherein the raised polygon of the locator plate has an apex oriented toward an incisal portion of the dental arch indicating a proper orientation of the 3D dental model with respect to the raised polygon of the locator plate.

10. The method of claim 8 wherein the raised polygon of the locator plate and the polygon cutout within the 3D printed locator tab are pentagonal.

11. The method of claim 10, wherein the pentagonal raised polygon includes a rectangular portion and a triangular portion, and an apex of the triangular portion is removed to produce a gap between the apex of the triangular portion and the 3D dental model.

12. The method of claim 11, wherein when the 3D dental model is secured to the locator plate, a defined gap exists between three sides of the rectangular portion of the pentagonal raised polygon and the polygon cutout within the 3D printed locator tab.

13. The method of claim 12, wherein the at least one ball plunger includes a pair of ball plungers positioned within the raised pentagon.

14. The method of claim 8, further comprising:
trimming the thermoformed polymer sheet post thermoforming.

15. The method of claim 8, further comprising:
transporting the secured the 3D dental model to the locator plate to a quality control station.

16. The method of claim 8, further comprising:
transporting the secured the 3D dental model to the locator plate to a different location within for further processing and positioning the locator plate within the different location using the 3D printed locator tab.

17. A system for thermoforming an orthodontic aligner, comprising:
a locator plate having a raised polygon extending from a surface of the locator plate;
at least one ball plunger positioned within the raised pentagon, the at least one ball plunger having a cylindrical body, a spring, and a ball extending partially outside the cylindrical body;
a 3D dental model including a positive model of a dental arch, and a 3D printed locator tab positioned within an interior of the dental arch,
wherein the 3D dental model defines edges of a polygon cutout within the 3D printed locator tab, and
wherein the 3D dental model mates with the locator plate by positioning the raised polygon within the polygon cutout, and engaging the ball of the ball plunger with a portion of the polygon cutout; and
a heat source for thermoforming a polymer sheet over the 3D dental model once secured to the locator plate.

18. The system of claim 17, wherein the 3D printed locator tab includes cutout lettering or raised lettering positioned along one or more edges of the polygon cutout.

19. The system of claim 18, further comprising:
a camera for viewing and identifying the cutout lettering or raised lettering positioned along one or more edges of the polygon cutout.

20. The system of claim 17, wherein the locator plate further defines a plurality of channels in fluid communication with a vacuum pump to generate a vacuum within the locator plate.

21. The system of claim 17, wherein the locator plate has a modular design allowing the raised polygon to be secured to and removed from the locator plate.

22. The system of claim 17, wherein the locator plate further comprises a removable active insert including the at least one ball plunger positioned within the raised polygon, and a bottom ball plunger extending from a surface of the removable active insert opposite from the raised polygon.
